(19) United States
(12) Patent Application Publication
(10) Pub. No.: US 2009/0273766 A1
(43) Pub. Date: Nov. 5, 2009

(54) APPARATUS AND METHOD FOR EXPOSURE AND METHOD OF MANUFACTURING DEVICE

(75) Inventors: Keita Sakai, Utsunomiya-shi (JP); Sunao Mori, Utsunomiya-shi (JP); Yuichi Iwasaki, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/420,734

(22) Filed: Apr. 8, 2009

(30) Foreign Application Priority Data
Apr. 11, 2008 (JP) 2008-103555
Feb. 27, 2009 (JP) 2009-046209

(51) Int. Cl. G03B 27/52

(52) U.S. Cl. 355/30; 355/77

(57) ABSTRACT

An exposure apparatus includes a projection optical system that projects light from an original to a substrate, and a supply device that supplies liquid containing a hydrocarbon compound to a gap between the final surface of the projection optical system and the substrate. The exposure apparatus exposes the substrate to light via the liquid filling the gap. The exposure apparatus further includes an adding device that adds water to the liquid to be supplied by the supply device.

### BACKGROUND OF THE INVENTION

1. Field of the Invention

The present invention relates to an exposure apparatus that exposes a substrate to light via liquid filling a gap between the substrate and the final surface of a projection optical system.

2. Description of the Related Art

A reduction projection exposure apparatus has been used in manufacture of a fine semiconductor device, such as a semiconductor memory or a logic circuit, using a photolithography technique. The reduction projection exposure apparatus allows a projection optical system to project the image of a circuit pattern drawn in a reticle onto a substrate, e.g., a wafer, thus transferring the circuit pattern to the wafer.

A minimum dimension (resolution) that can be transferred by the reduction projection exposure apparatus is proportional to the wavelength of light for exposure and is inversely proportional to the numerical aperture (NA) of the projection optical system. Therefore, the shorter the wavelength is and the higher the NA is, the higher the resolution is. Accordingly, a reduction in wavelength of exposure light is implemented in response to the needs for recent finer pattern designing of semiconductor devices. Consequently, ultraviolet rays used have been shifted to those having shorter wavelengths, e.g., a KrF excimer laser beam having a wavelength of about 248 nm) and an ArF excimer laser beam having a wavelength of about 193 nm.

Under such circumstances, attention is paid to liquid immersion exposure as a technique for further increasing the resolution using an ArF excimer laser as a light source. According to the immersion exposure, a gap between a wafer and the final surface, located the closest to the wafer, of a projection optical system is filled with liquid to increase the NA of the projection optical system, thus increasing the resolution. When let the index of refraction (hereinafter, “refractive index”) of a medium denote n, the NA of the projection optical system is expressed as follows: NA=n×sin θ. Therefore, when the gap therebetween is filled with a medium having a refractive index (n>1) higher than that of air, the NA can be increased to n.

The higher the refractive index of liquid used is, the higher the resolution is expected to be. As for successor technology of the immersion exposure apparatus using pure water, therefore, an immersion exposure apparatus using liquid (high refractive index liquid) having a refractive index higher than that of pure water has been proposed (refer to, for example, PCT Publication Nos. WO 2005/114711 and WO 2005/119371).

Furthermore, a pattern forming method using a solution prepared by adding water to a nonaqueous solution as an immersion liquid has been proposed (refer to Japanese Patent No. 4054285). In the use of immersion liquid having high water repellency, e.g., perfluoro polyether, the immersion liquid having water repellency remains on the surface of a resist film, thus causing poor development. Therefore, several percent by weight (hereinafter, abbreviated to “wt %”) of water is added to the immersion liquid so that the surface has hydrophilicity, thus improving the poor development.

When the immersion liquid contains an alicyclic hydrocarbon compound (including an alicyclic hydrocarbon compound containing a silicon atom in its ring structure), the immersion liquid is not a liquid having water repellency. Accordingly, this immersion liquid does not cause poor development. It is therefore unnecessary to add water to the immersion liquid in order to overcome poor development. In addition, only several tens ppm of water can be dissolved in the immersion liquid containing an alicyclic hydrocarbon compound or the alicyclic hydrocarbon compound containing a silicon atom in its ring structure. In the use of the immersion liquid containing an alicyclic hydrocarbon compound, therefore, it is difficult to prepare a solution doped with several wt % of water as disclosed in Japanese Patent No. 4054285.

When the immersion exposure apparatus uses a high refractive index liquid as an immersion liquid, it is preferable in terms of cost to recycle the liquid while refining the contaminated liquid (refer to PCT Publication Nos. WO 2005/119371 and WO 2006/080250). Liquid refining may include impurity removal and oxygen removal.

The immersion exposure apparatus using a high refractive index liquid has a problem different from that of the immersion exposure apparatus using pure water. Specifically, the problem is contamination of the final surface of a projection optical system. Exposure light emitted from, for example, an ArF excimer laser causes the oxidation or decomposition reaction of a high refractive index liquid containing a hydrocarbon compound, so that produced matter deposits on the surface of a lens. The deposit reduces the transmittance of exposure light, thus causing unevenness in illuminance.

As for the above-described liquid refining, in the impurity removal, when a highly polar substance is absorbed and removed, water in the immersion liquid is also removed. In the oxygen removal, when oxygen is removed by nitrogen bubbling, water in the immersion liquid is also removed. Therefore, even in the use of an immersion liquid previously doped with water as disclosed in Japanese Patent No. 4054285, if water is removed during refining of the liquid, it is difficult to supply the immersion liquid containing sufficient water.

### SUMMARY OF THE INVENTION

The present invention provides an exposure apparatus capable of reducing contamination of the final surface of a projection optical system.

According to an aspect of the present invention, an exposure apparatus includes a projection optical system configured to project light from an original to a substrate, a supply device configured to supply liquid containing a hydrocarbon compound to a gap between the final surface of the projection optical system and the substrate so that the exposure apparatus exposes the substrate to light via the liquid filling the gap, and an adding device configured to add water to the liquid to be supplied by the supply device.

According to another aspect of the present invention, there is provided a method for exposing a substrate to light via liquid containing a hydrocarbon compound, the liquid filling a gap between the final surface of a projection optical system and the substrate, the projection optical system projecting light from an original to the substrate. The exposure method includes adding water to the liquid, and exposing the substrate to light via the water-added liquid filling the gap.

According to further another aspect of the present invention, there is provided a method of manufacturing a device, the method including exposing a substrate to light using the above-described exposure apparatus or exposure method, developing the exposed substrate, and processing the developed substrate to manufacture the device.

According to the present invention, for example, the exposure apparatus capable of reducing contamination of the final surface of the projection optical system can be provided.

Other aspects and advantages besides those discussed above shall be apparent to those skilled in the art from the description of a preferred embodiment of the invention which follows. In the description, reference is made to accompanying drawings, which form apart thereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic diagram illustrating the structure of an immersion exposure apparatus.

FIG. 2 is a schematic diagram illustrating an immersion exposure apparatus according to a first embodiment of the present invention.

FIG. 3 is a diagram explaining effects.

FIG. 4 is a schematic diagram illustrating an immersion exposure apparatus according to a second embodiment.

FIG. 5 is a schematic diagram illustrating a water adding unit in accordance with a third embodiment.

FIG. 6 is a schematic diagram illustrating another water adding unit in the third embodiment.

FIG. 7 is a schematic diagram illustrating a water adding unit in a fourth embodiment.

FIG. 8 is a schematic diagram illustrating an immersion exposure apparatus according to a fifth embodiment.

### DESCRIPTION OF THE EMBODIMENTS

Various embodiments of an immersion exposure apparatus (also simply called “exposure apparatus”) according to the present invention will be described below with reference to the drawings.

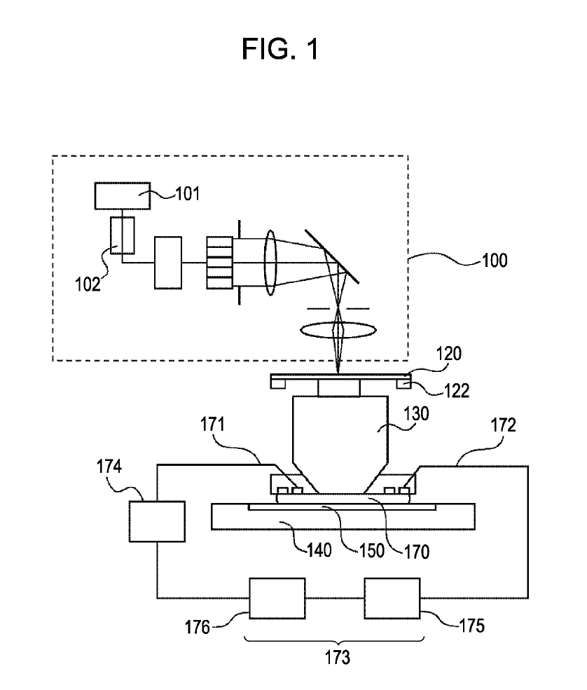

FIG. 1 is a schematic diagram of an immersion exposure apparatus according to a preferred embodiment of the present invention. The immersion exposure apparatus includes an illumination unit 100, a reticle stage 122 holding a reticle 120, a projection optical system 130, a substrate stage 140 holding a substrate 150 to be exposed to light, a liquid supply unit 171, and a water adding unit 174. In this instance, the reticle is also called an original or mask. The immersion exposure apparatus is of the liquid immersion type in which a pattern formed in the reticle 120 is projected to the substrate 150 via immersion liquid (also simply referred to as “liquid”) 170 filling a gap between the substrate 150 and the final surface of the projection optical system 130. Although the immersion exposure apparatus according to the embodiment of the present invention is a step-and-scan projection exposure apparatus, a step-and-repeat projection exposure method or another exposure method may be applied to the exposure apparatus.

The illumination unit 100 includes a laser 101 functioning as a light source and a beam shaping optical system 102. As for the laser 101, an ArF excimer laser at a wavelength of about 193 nm, a KrF excimer laser at a wavelength of about 248 nm, or an F2 excimer laser at a wavelength of about 157 nm is available.

The immersion liquid 170 is supplied from the liquid supply unit 171 to the gap between the final surface of the projection optical system 130 and the substrate 150 and is then recovered by a liquid recovery unit 172 through a recovery nozzle disposed in the vicinity of the final surface of the projection optical system 130. Thus, the gap between the final surface and the substrate 150 can be filled with the immersion liquid 170, i.e., the immersion state is provided. The transmittance of the recovered immersion liquid 170 to exposure light is degraded due to exposure light irradiation, contact with the substrate 150, and/or contact with the atmosphere in the vicinity of the substrate 150. The recovered immersion liquid 170 is processed by a liquid refining unit 173, so that the transmittance of the immersion liquid 170 to exposure light is recovered. The liquid refining unit 173 can include at least one of an impurity removing unit 175 and an oxygen removing unit 176. The immersion liquid 170 processed by the liquid refining unit 173 is further processed by the water adding unit 174, so that the immersion liquid 170 containing an appropriate amount of water can be again supplied to the gap between the final surface and the substrate 150. Adding water to the immersion liquid 170 prevents foreign matter from depositing on the final surface.

A material for the immersion liquid 170 is selected from substances having high transmittance at exposure wavelength and good matching with resist processing. The immersion liquid 170 may contain, for example, a hydrocarbon compound. More specifically, the immersion liquid 170 may contain an alicyclic hydrocarbon compound, such as decalin, bicyclohexyl, cyclohexane, or n-heptane, or an alicyclic hydrocarbon compound containing a silicon atom in its ring structure.

Concentration of water in the immersion liquid 170 containing water added by the water adding unit 174 is preferably in the range of 10% to 100% of saturated concentration (saturated water concentration) of the hydrocarbon compound in the immersion liquid.

The present invention will now be described in more detail with respect to various embodiments.

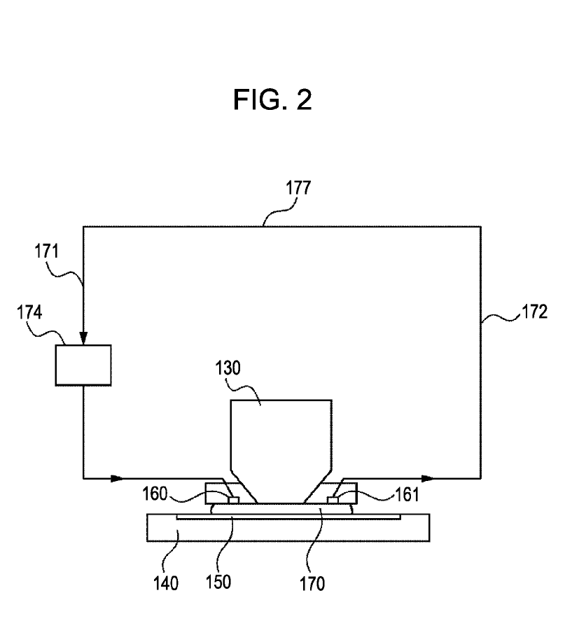

A first embodiment relates to an immersion exposure apparatus including a liquid supply unit that supplies immersion liquid to a gap between a projection optical system and a substrate to be exposed to light, and a water adding unit that adds water to the immersion liquid. The immersion exposure apparatus according to the first embodiment further includes a liquid recovery unit that recovers the immersion liquid from the gap between the projection optical system and the substrate and a liquid circulating unit that transfers the recovered immersion liquid to the liquid supply unit. FIG. 2 schematically illustrates part of the immersion exposure apparatus according to the present embodiment.

The immersion exposure apparatus according to the present embodiment is of the step-and-scan type using an ArF excimer layer as a light source. As for immersion liquid 170 to be supplied to the gap between the final surface of the projection optical system, indicated at 130, and a substrate 150 to be exposed to light, a high refractive index liquid having a refractive index of 1.64 is used.

The immersion liquid (high refractive index liquid) 170 is supplied from the liquid supply unit, indicated at 171, through the water adding unit, indicated at 174, and a liquid supply nozzle 160 downstream of the unit 174 to the gap between the final surface of the projection optical system 130 and the substrate 150. The supplied immersion liquid 170 is recovered through a liquid recovery nozzle 161 by the liquid recovery unit, indicated at 172, using a technique such as vacuum suction. The recovered immersion liquid 170 is transferred through the liquid circulating unit, indicated at 177, to the liquid supply unit 171. The substrate is exposed to an ArF excimer laser beam via the immersion liquid 170, so that a pattern is transferred to the substrate with high resolution.

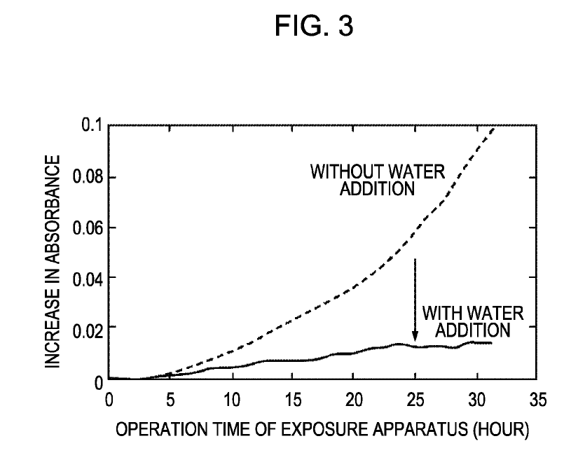

This immersion exposure apparatus was operated and the amount of foreign matter deposited on the final surface of the projection optical system 130 was measured versus operation time. FIG. 3 illustrates a result of measurement. It can be seen that the amount of deposit (increase in absorbance) with the use of the water adding unit 174 was remarkably smaller than that without the use of the water adding unit. As a result of FIG. 3, it has been shown that the immersion exposure apparatus according to the present embodiment including the water adding unit can reduce the amount of foreign matter deposited on the final surface of the projection optical system 130 to provide stable exposure performance.

In the present embodiment, the immersion liquid 170 is reused while being circulated by the liquid circulating unit 177. To reduce the amount of deposit on the final surface of a lens in the projection optical system 130, the immersion liquid 170 does not have to be necessarily circulated. The liquid circulating unit 177 may be removed and the recovered immersion liquid 170 may be discharged to the outside of the apparatus. However, a material for the immersion liquid 170 is higher in cost than water. In addition, the immersion liquid 170 seriously affects the environment. Given a reduction in cost for exposure processing, therefore, it is more preferable to circulate and reuse the immersion liquid.

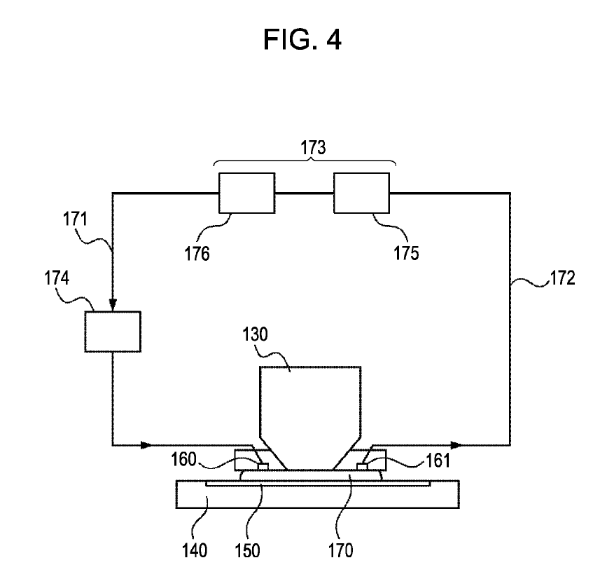

A second embodiment relates to an immersion exposure apparatus including a liquid circulating unit that further includes a liquid refining unit which restores the transmittance of immersion liquid to exposure light (having a wavelength of, for example, 193 nm). The liquid refining unit includes at least one of an impurity removing unit that removes an impurity in the immersion liquid and an oxygen removing unit that removes oxygen dissolved in the immersion liquid. FIG. 4 schematically illustrates part of the immersion exposure apparatus according to the present embodiment.

The immersion exposure apparatus according to the present embodiment is of the step-and-scan type using an ArF excimer laser as a light source. As for immersion liquid 170 to be supplied to a gap between the final surface of a projection optical system 130 and a substrate 150 to be exposed to light, a high refractive index liquid having a refractive index of 1.64 is used.

The immersion liquid (high refractive index liquid) 170 is supplied from a liquid supply unit 171 through a water adding unit 174 and a liquid supply nozzle 160 downstream of the unit 174 to the gap between the final surface of a lens in the projection optical system 130 and the substrate 150. The supplied immersion liquid is recovered through a liquid recovery nozzle 161 by a liquid recovery unit 172 using a technique such as vacuum suction. The transmittance of the recovered immersion liquid to exposure light is deteriorated due to exposure light irradiation, contact with resist on the surface of the substrate 150, and/or contact with the atmosphere in the vicinity of the substrate 150. The exposure light irradiation causes the decomposition or oxidation of the immersion liquid, and matter produced by the decomposition or oxidation deteriorates the transmittance of the immersion liquid. In some cases, matter leaching from resist into the immersion liquid deteriorates the transmittance of the immersion liquid. If oxygen in the atmosphere dissolves into the immersion liquid, the dissolved oxygen deteriorates the transmittance of the immersion liquid. The transmittance of the immersion liquid deteriorated by various factors is restored by processing the immersion liquid through the impurity removing unit, indicated at 175, and the oxygen removing unit, indicated at 176, in the liquid refining unit indicated at 173. Although a member absorbing a highly polar substance and removing the substance is used as the impurity removing unit, a filter removing particulate matter may also be used. As for the oxygen removing unit, a method of mixing gas, such as nitrogen or helium, containing a low concentration of oxygen with the immersion liquid or a degassing membrane can be used. The immersion liquid processed through the liquid refining unit 173 is transferred to the liquid supply unit 171 and is then processed through the water adding unit 174. After that, the resultant immersion liquid is supplied to the gap between the projection optical system 130 and the substrate 150. The substrate is exposed to the ArF excimer laser beam via the immersion liquid 170, so that a pattern is transferred to the substrate with high resolution.

This immersion exposure apparatus was operated and the amount of foreign matter deposited on the final surface of the projection optical system 130 was measured versus operation time. As a result, the amount of deposit (increase in absorbance) was smaller than that in FIG. 3. Since an impurity or dissolved oxygen in the immersion liquid can be effectively removed by the liquid refining unit 173, probably, the deposition of foreign matter was further suppressed. It has been shown that the immersion exposure apparatus according to the present embodiment including the water adding unit and the liquid refining unit can reduce the amount of foreign matter deposited on the final surface of the projection optical system 130 to provide stable exposure performance.

In the present embodiment, the impurity removing unit and the oxygen removing unit are used to remove an impurity or dissolved oxygen in the immersion liquid. However, the impurity removing unit and the oxygen removing unit do not have to be necessarily used in combination with each other in order to reduce the amount of foreign matter deposited on the final surface of the projection optical system 130. For example, the frequency of exchanging the immersion liquid or the amount of the immersion liquid is increased, so that the amount of foreign matter deposited can be reduced without using the impurity removing unit. In addition, when concentration of oxygen in the vicinity of the substrate to be exposed is reduced by supply of, for example, nitrogen (hereinafter, “nitrogen purge”), the oxygen removing unit can be removed. A material for the immersion liquid is higher in cost than water and the immersion liquid seriously affects the environment. In addition, nitrogen purge involves cost. To suppress the amount of immersion liquid used, it is preferred to use at least one of the impurity removing unit and the oxygen removing unit as disclosed in the present embodiment.

In the immersion exposure apparatus according to the present embodiment, the water adding unit is placed downstream of the liquid refining unit including at least one of the impurity removing unit and the oxygen removing unit. In other words, the immersion liquid recovered from the gap between the projection optical system and the substrate to be exposed is processed by the liquid refining unit and is then processed by the water adding unit. After that, the resultant immersion liquid is again supplied to the gap between the projection optical system and the substrate. If the impurity removing unit uses, for example, silica gel that absorbs and removes a highly polar substance, water in the immersion liquid is also removed. As for oxygen removal, if oxygen is removed by nitrogen bubbling, water in the immersion liquid is also removed. To add sufficient water to the immersion liquid, therefore, the water adding unit is preferably placed downstream of the liquid refining unit.

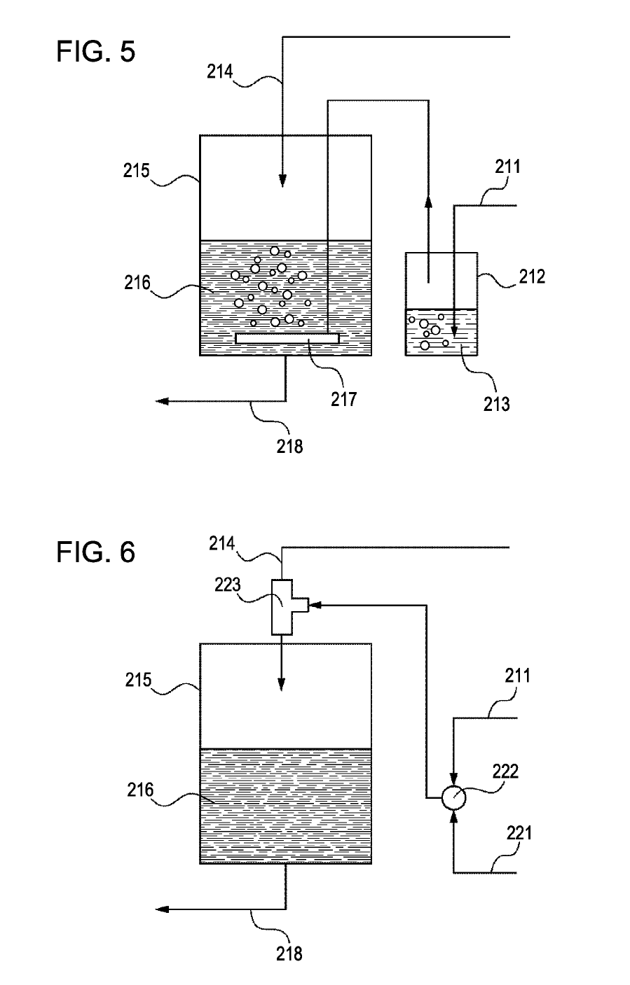

A third embodiment relates to an immersion exposure apparatus including a water adding unit that brings humidified gas into contact with immersion liquid to add water to the immersion liquid. FIG. 5 schematically illustrates the water adding unit in the immersion exposure apparatus according to the present embodiment.

According to the present embodiment, the water adding unit includes a humidifying section that humidifies gas and a mixing section that mixes the humidified gas with the immersion liquid. The humidifying section includes a gas supply member 211, a humidifying container 212, and water 213. In the humidifying section, gas is brought into contact with water, thereby humidifying the gas. As for the gas supplied by the gas supply member 211, a gas having no absorption in the ultraviolet wavelength range, e.g., nitrogen or helium is preferably used. For example, since oxygen has absorption in the ultraviolet wavelength range, concentration of oxygen in the gas is preferably not greater than 0.5 wt %. The mixing section, which mixes the humidified gas with the immersion liquid, includes a bubbler 217 that supplies the humidified gas as small bubbles into immersion liquid 216, a container 215, and flow paths 214 and 218. The humidified gas is added as small bubbles into the immersion liquid, thus increasing the contact area of the humidified gas with the immersion liquid. Consequently, water can be efficiently added to the immersion liquid. Furthermore, when gas containing a low concentration of oxygen is used as the humidified gas, the water adding unit can also have the capability of the oxygen removing unit.

FIG. 6 schematically illustrates another water adding unit in accordance with the present embodiment. The water adding unit also includes a humidifying section that humidifies gas and a mixing section that mixes the humidified gas with immersion liquid. The humidifying section includes a gas supply member 211, a water supply member 221, and a mixing member 222. The mixing member 222 mixes gas with water to humidify the gas. Controlling the mixing ratio of gas to water obtains the gas having a predetermined humidity. Accordingly, an advantage of such a method is to control the amount of water added to the immersion liquid. The mixing section, which mixes the humidified gas with the immersion liquid, includes a gas-liquid mixing member 223, a container 215, and flow paths 214 and 218. The humidified gas is mixed with the immersion liquid on the upstream side of the container 215, so that the humidified gas can be effectively mixed with the immersion liquid. After the gas is separated from the immersion liquid 216 in the container 215, the water-added immersion liquid is transferred through the flow path 218. When gas having a low concentration of oxygen is used as the gas to be humidified, the water adding unit can also have the capability of the oxygen removing unit.

When the water adding unit illustrated in FIG. 5 or 6 is included in the immersion exposure apparatus, the same advantage as those of the first and second embodiments, namely, the advantage of reducing the amount of foreign matter deposited on the final surface can be obtained.

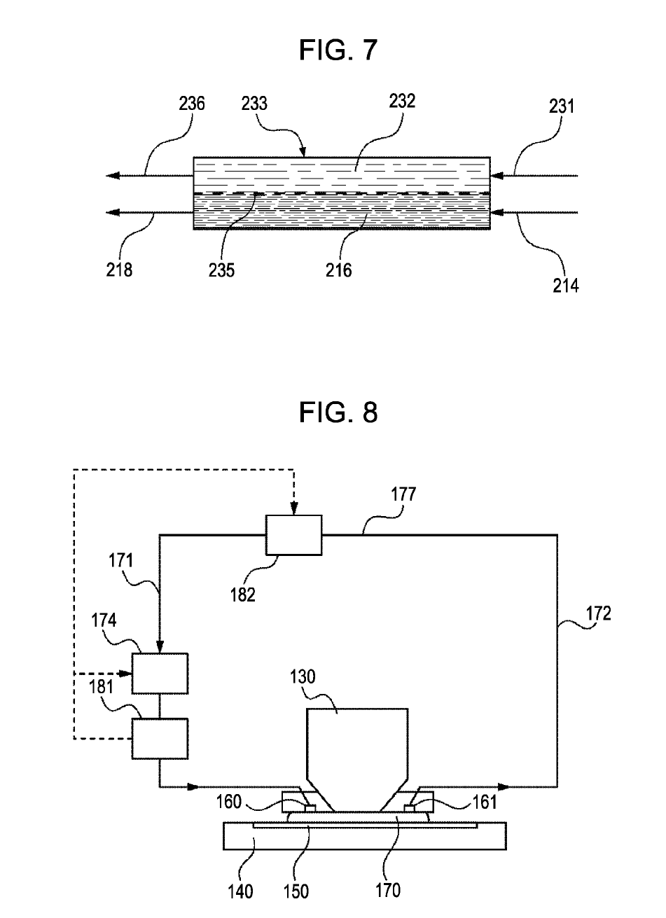

A fourth embodiment relates to an immersion exposure apparatus including a water adding unit that brings water into contact with immersion liquid to add the water to the immersion liquid. FIG. 7 schematically illustrates the water adding unit in the immersion exposure apparatus according to the present embodiment.

According to the present embodiment, the water adding unit, indicated at 233, brings water 232 into contact with immersion liquid 216 via a porous membrane 235, thus adding the water to the immersion liquid. Referring to FIG. 7, the water 232 flows from a flow path 231 to a flow path 236 and the immersion liquid 216 flows from a flow path 214 to a flow path 218. The directions of flow are not limited to those in FIG. 7. As for the water adding unit 233, a membrane contactor including many porous hollow fibers, for example, pHasor® II Membrane Contactor made by Entegris, Inc. may be used. Increasing the contact area of water with the immersion liquid results in an increase in efficiency of water addition.

It is preferred that the purity of the water 232 supplied from the flow path 231 to the water adding unit 233 be high. In particular, concentration of a substance having absorption in the ultraviolet wavelength range has to be suppressed to a low level. For example, concentration of oxygen dissolved in the water 232 is preferably not greater than 0.2 ppm. Controlling the amount of impurity in the water 232 to a low level prevents the impurity from being distributed in the immersion liquid 216, so that the transmittance of the immersion liquid 216 in the ultraviolet wavelength range or the quality of the immersion liquid can be maintained.

In addition, gas dissolved in the water 232 is removed, so that gas dissolved in the immersion liquid can be removed. The gas dissolved in the immersion liquid is removed, so that bubbles generated in the immersion liquid can be eliminated in a short time. Concentration of gas dissolved in the water 232 is held at or below 70% of saturated gas concentration, so that the life of the bubbles can be sufficiently reduced. Consequently, exposure light is prevented from scattering due to bubbles, so that a defect caused during exposure can be reduced.

In the use of the immersion exposure apparatus including the water adding unit illustrated in FIG. 7, the same advantage as those in the first and second embodiments, namely, the advantage of reducing the amount of foreign matter deposited on the final surface can be obtained. The water adding unit according to the present embodiment may include at least one of an impurity removing unit, an oxygen removing unit, and a degassing unit upstream of the flow path 231.

A fifth embodiment relates to an immersion exposure apparatus including a liquid supply unit that supplies immersion liquid to a gap between a projection optical system and a substrate to be exposed to light and includes a water adding unit adding water to the immersion liquid. The immersion exposure apparatus according to the present embodiment further includes a liquid recovery unit that recovers the immersion liquid from the gap between the projection optical system and the substrate, a liquid circulating unit that transfers the recovered immersion liquid to the liquid supply unit, a water removing unit that removes water in the immersion liquid, and a water measuring unit that measures concentration of water in the immersion liquid. According to the present embodiment, the water adding unit and the water removing unit are controlled in accordance with measurement by the water measuring unit, thus regulating concentration of water in the immersion liquid. FIG. 8 schematically illustrates part of the immersion exposure apparatus according to the present embodiment.

The immersion exposure apparatus according to the present embodiment is of the step-and-scan type using an ArF excimer laser as a light source. As for an immersion liquid 170 to be supplied to the gap between the final surface of the projection optical system, indicated at 130, and a substrate 150 to be exposed, a high refractive index liquid having a refractive index of 1.64 is used.

The immersion liquid (high refractive index liquid) 170 is supplied from the liquid supply unit, indicated at 171, through the water adding unit, indicated at 174, and the water measuring unit, indicated at 181, and a liquid supply nozzle 160 to the gap between the final surface of a lens in the projection optical system 130 and the substrate 150. The supplied immersion liquid 170 is recovered through a liquid recovery nozzle 161 by the liquid recovery unit, indicated at 172, using a technique such as vacuum suction. The recovered immersion liquid 170 is transferred to the liquid supply unit 171 by the liquid circulating unit, indicated at 177, including the water removing unit indicated at 182. The water adding unit 174 and the water removing unit 182 are controlled in accordance with measurement by the water measuring unit 181 so that concentration of water in the immersion liquid can be stabilized. Stabilizing concentration of water can increase the stability in the refractive index of the immersion liquid. The substrate is exposed to an ArF excimer laser beam via the immersion liquid 170 whose refractive index is stabilized, so that a pattern can be transferred to the exposed substrate with stable high resolution. As for the water measuring unit 181, a typical moisture meter for liquid processing can be used. As for the water removing unit 182, a method of heating the immersion liquid to remove water or a method of supplying bubbles of dry gas into the immersion liquid to remove water may be used.

This immersion exposure apparatus was operated and the amount of foreign matter deposited on the final surface of the projection optical system 130 was measured versus operation time. The same result of measurement as that in FIG. 3 in the use of the water adding unit was obtained. In addition, the stability of the refractive index of the immersion liquid 170 was increased, so that the uniformity of line width in the exposed substrate was improved.

In the present embodiment, concentration of water in the immersion liquid was controlled using the water removing unit and the water measuring unit in addition to the water adding unit. When the exposure apparatus includes any one of the water removing unit and the water measuring unit, concentration of water in the immersion liquid can be regulated (adjusted). For example, in the use of the water adding unit in FIG. 6, concentration of water in the immersion liquid can be controlled by the water adding unit and the water measuring unit without using the water removing unit. When the water measuring unit is not used but the water adding unit and the water removing unit are used, stable concentration of water can be achieved.

A sixth embodiment relates to a method of manufacturing a device using any of the above-described apparatuses and methods for exposure. In this instance, examples of a device include a semiconductor device and a liquid crystal display device. The device is manufactured by any of the above-described apparatuses and methods for exposure. In other words, the device is manufactured by exposing a substrate (e.g., a wafer or glass plate) coated with a photosensitive material (photoresist) to light, developing the exposed substrate, and processing the developed substrate.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-103555 filed Apr. 11, 2008 and Japanese Patent Application No. 2009-046209 filed Feb. 27, 2009, which are hereby incorporated by reference herein in their entirety.

What is claimed is:

1. An exposure apparatus comprising:
a projection optical system configured to project light from an original to a substrate;
a supply device configured to supply liquid containing a hydrocarbon compound to a gap between the final surface of the projection optical system and the substrate so that the exposure apparatus exposes the substrate to light via the liquid filling the gap; and
an adding device configured to add water to the liquid to be supplied by the supply device.

2. An apparatus according to claim 1, further comprising:
a recovery device configured to recover the liquid from the gap; and
a transfer device configured to transfer the liquid recovered by the recovery device to the supply device.

3. An apparatus according to claim 2, wherein the transfer device includes a refining device configured to refine the liquid.

4. An apparatus according to claim 3, wherein the refining device includes at least one of an impurity removing device and an oxygen removing device, the impurity removing device being configured to remove an impurity in the liquid, the oxygen removing device being configured to remove oxygen dissolved in the liquid.

5. An apparatus according to claim 1, wherein the adding device is configured to bring the liquid into contact with humidified gas to add water to the liquid.

6. An apparatus according to claim 5, wherein the adding device is configured to bring the liquid into contact with the humidified gas in which concentration of oxygen is not greater than 0.5 percent by weight.

7. An apparatus according to claim 1, wherein the adding device is configured to bring the liquid into contact with water to add the water to the liquid.

8. An apparatus according to claim 7, wherein the adding device is configured to bring the liquid into contact with the water in which concentration of oxygen dissolved is not greater than 0.2 ppm.

9. An apparatus according to claim 7, wherein the adding device is configured to bring the liquid into contact with the water in which concentration of gas dissolved is not greater than 70 percent of saturated gas concentration.

10. An apparatus according to claim 1, further comprising a water removing device configured to remove water in the liquid.

11. An apparatus according to claim 1, further comprising a measuring device configured to measure concentration of water in the liquid.

12. An apparatus according to claim 11, wherein the adding device is configured to regulate concentration of water in the liquid based on measurement by the measuring device.

13. An apparatus according to claim 10, further comprising a measuring device configured to measure concentration of water in the liquid,
wherein at least one of the adding device and the water removing device is configured to regulate concentration of water in the liquid based on measurement by the measuring device.

14. An apparatus according to claim 1, wherein the adding device is configured to add water to the liquid so that concentration of water in the liquid is in the range of 10 percent to 100 percent of the saturated concentration.

15. An apparatus according to claim 1, wherein the supply device is configured to supply liquid containing an alicyclic hydrocarbon compound.

16. An apparatus according to claim 3, wherein the supply device includes a supply nozzle from which the liquid is supplied to the gap, and
the adding device is arranged on a flow path of the liquid downstream of the refining device and upstream of the supply nozzle.

17. A method of exposing a substrate to light via liquid containing a hydrocarbon compound, the liquid filling a gap between the final surface of a projection optical system and the substrate, the projection optical system projecting light from an original to the substrate, the method comprising:
adding water to the liquid; and
exposing the substrate to light via the water-added liquid filling the gap.

18. A method according to claim 17, further comprising:
supplying the water-added liquid to the gap;
recovering the liquid from the gap;
refining the recovered liquid;
adding water to the refined liquid; and
supplying the refined and water-added liquid to the gap.

19. A method of manufacturing a device, the method comprising:
exposing a substrate to light using an exposure apparatus;
developing the exposed substrate; and
processing the developed substrate to manufacture the device,
the exposure apparatus including a projection optical system projecting light from an original to the substrate, a supply device supplying liquid containing a hydrocarbon compound to a gap between the final surface of the projection optical system and the substrate so that the exposure apparatus exposes the substrate to light via the liquid filling the gap, and an adding device adding water to the liquid to be supplied by the supply device.

20. A method of manufacturing a device, the method comprising:
exposing a substrate to light using an exposure method;
developing the exposed substrate; and
processing the developed substrate to manufacture the device,
the exposure method exposing the substrate to light via liquid which contains a hydrocarbon compound and fills a gap between the final surface of a projection optical system and the substrate, the projection optical system projecting light from an original to the substrate, the exposure method including adding water to the liquid, and exposing the substrate via the water-added liquid filling the gap.
